(19) United States
(12) Patent Application Publication
(10) Pub. No.: US 2008/0290538 A1
(43) Pub. Date: Nov. 27, 2008

(54) EXTRUDER RAMP-UP CONTROL SYSTEM AND METHOD

(76) Inventor: Jeffrey J. Biesenberger, Columbus, OH (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/124,659

(22) Filed: May 21, 2008

Related U.S. Application Data
(60) Provisional application No. 60/924,636, filed on May 23, 2007.

(51) Int. Cl. B29C 47/92

(52) U.S. Cl. 264/40.3; 425/149

(57) ABSTRACT

An extrusion system is provided including an extruder, a screen changer, an operator interface, and a controller. The system further includes a pressure sensor for detecting an extrusion flow pressure between the extruder and the screen changer. A method of ramping up an extruder is also provided including the steps of detecting a pressure upstream from an extrusion screen filter; comparing the upstream pressure to a user-defined threshold pressure; and increasing an extrusion output if the upstream pressure exceeds the threshold pressure.

### RELATED APPLICATION

The present disclosure claims the benefit of priority based on U.S. Provisional Patent Application No. 60/924,636 filed May 23, 2007, which is incorporated herein by reference.

### TECHNICAL FIELD

The present disclosure relates to an extruder ramp-up control system and method, and more particularly, to a system and method for ramping up the output of an extruder drive and motor in response to a pressure measurement.

### BACKGROUND

Traditionally, plastic products are made by extruding materials, such as thermoplastic resins, into one or more dies. In some cases, the materials are heated, melted, and extruded through the use of a die having a predetermined shape. For example, when forming products, such as pipes, melted resin is provided from a heated source to one or more dies, in which the resin is urged into an annular shape. Each die has a corresponding extruder (or extruders in the case of coextrusion), which is adjusted to control the level of melt flow directed to each die.

Control of the extruder and melt flow is used to achieve desired product characteristics, such as material thickness, density, and strength. Moreover, control techniques are used to counteract natural inconsistencies and disruptions in the extrusion process, such as changes in material lots, filters, and flow paths. For this purpose, some closed-loop systems exist that may detect the pressure of melt flow entering a die and compare it to a reference pressure value. The extruder output is adjusted in response to a detected surplus or deficiency in melt flow pressure.

The prior art extruder control systems and methods, however, suffer from several deficiencies. For instance, the use of complex closed-loop feedback systems increase the number of sensors and parts, and the cost of production and repair. Likewise, the use of geared pumps and other sophisticated devices for monitoring and compensating for flow pressure is prohibitively expensive.

Moreover, the detection of flow pressure at the die entrance is often insufficiently responsive, and results in a delayed reaction in extruder output, which causes undesirable changes in material properties, such as variation in material thickness. Such imperfections reduce product performance and negatively impact customer perceptions. Greater material thickness variation also necessitates an increase in raw material usage and, therefore, results in further increases in production costs. The inability to adequately control material flow properties in the prior art thus reduces the efficiency and increases the cost of the extrusion process.

Accordingly, there is a need for an improved extruder ramp-up system and method for improving the quality, efficiency, and cost of the extrusion process.

### SUMMARY OF THE DISCLOSURE

In accordance with one disclosed exemplary embodiment, an extrusion system is provided including: an extruder and a screen changer connected by a flow path; a first pressure sensor disposed in the flow path between the extruder and the screen changer; an operator interface configured to receive an input value; and a controller in communication with the extruder, the first pressure sensor, and the operator interface. The first pressure sensor is configured to detect a pressure of material flowing from the extruder to the screen changer, and to generate a first signal in response to the detected pressure. The controller is configured to adjust an operating condition of the extruder based on a comparison between the first signal and the input value.

In accordance with a further disclosed exemplary embodiment, a method of operating an extrusion system is provided including the steps of: connecting an extruder and a screen changer with a flow path; disposing a first pressure sensor in the flow path between the extruder and the screen changer; providing an operator interface configured to receive an input value; providing a controller in communication with the extruder, the first pressure sensor, and the operator interface; detecting a pressure of material flowing from the extruder to the screen changer; generating a first signal in response to the detected pressure; and adjusting an operating condition of the extruder based on a comparison between the first signal and the input value.

In accordance with another exemplary embodiment, a method of operating an extrusion system is provided, including the steps of: detecting a pressure upstream from an extrusion screen filter; comparing the upstream pressure to a user-defined threshold pressure; and increasing an extrusion output if the upstream pressure exceeds the threshold pressure.

In accordance with a still further disclosed exemplary embodiment, a system is provided for optimizing a flow property of a material extruded from an extruder through a screen changer. The system includes: an extruder configured to extrude material having a variable material flow property; a sensor disposed in communication with material flowing from the extruder to the screen changer; and a controller configured to determine a material flow property of the material downstream of the extruder based on a measurement by the sensor; and to optimize the variable material flow property of the material extruded by the extruder based on the sensed material flow property.

In this respect, before explaining at least one embodiment of the invention in detail, it is to be understood that the invention is not limited in its application to the details of construction and to the arrangements of the components set forth in the following description or illustrated in the drawing. The invention is capable of embodiments in addition to those described and of being practiced and carried out in various ways. Also, it is to be understood that the phraseology and terminology employed herein, as well as the abstract, are for the purpose of description and should not be regarded as limiting.

The accompanying drawings, which are incorporated in and constitute a part of this specification, illustrate certain embodiments of the invention, and together with the description, serve to explain the principles of the invention.

As such, those skilled in the art will appreciate that the conception upon which this disclosure is based may readily be utilized as a basis for designing other structures, methods, and systems for carrying out the several purposes of the present invention. It is important, therefore, to recognize that the claims should be regarded as including such equivalent constructions insofar as they do not depart from the spirit and scope of the present invention.

### BRIEF DESCRIPTION OF THE DRAWING

FIG. 1 is a schematic view illustrating one embodiment of an extrusion system and an extruder ramp-up control system consistent with the present invention.

FIG. 2 is a flow chart illustrating one embodiment of an extruder ramp-up method consistent with the present invention.

### DESCRIPTION OF THE EXEMPLARY EMBODIMENTS

Reference will now be made in detail to the present embodiments of the invention, an example of which is illustrated in the accompanying drawings.

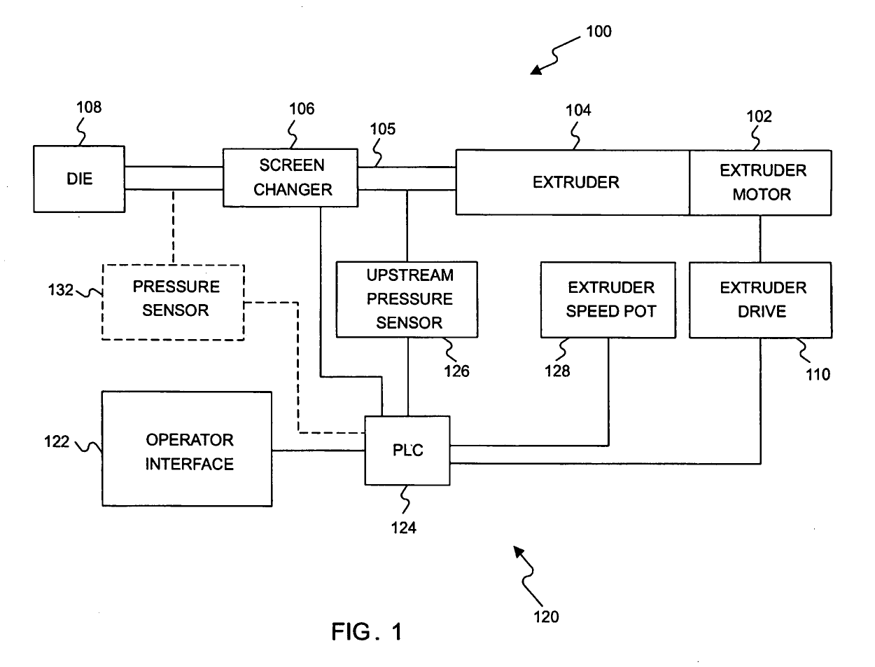

FIG. 1 illustrates one embodiment of an extrusion system 100. The extrusion system 100 may include an extruder 104, of any variety known in the art. For example, the extruder 104 may be a screw-type or pump-type extruder. In the event that coextrusion is performed, the extrusion system 100 may include multiple extruders 104. The extruder 104 may be disposed in connection with a hopper (not shown), one or more heating elements (not shown), an extruder motor 102, and an extruder drive 110. The extruder 104 may be configured to receive stock material, such as virgin plastic pellets, plant regrind, recycled flake, and/or powders, from the hopper, and to heat and compress the stock material to form a fluid melt. Plastic materials consistent with the present invention include most polymers, including but not limited to polymer blends, natural and synthetic resins, polyolefins, such as polyethylene and polypropylene, polyesters, polyamides, polyurethanes, polyvinyl chlorides, and thermoplastics elastomers. A screw or other conveying device in the extruder 104 may advance the plastic fluid melt along an interior passageway of the extruder 104. The extruder 104 also may be in fluid communication with a flowpath 105 at an end opposite from the hopper. The flowpath 105 may be configured to convey the fluid melt from the extruder 104 to a die 108 for forming a desired product.

The flowpath 105 may have disposed therein, a screen changer 106. Specifically, the screen changer 106 may be disposed in fluid communication with the flowpath 105 between the extruder 104 and the die 108. The screen changer 106 may include one or more screens for filtering dirt and other contaminants from the fluid melt before the fluid melt enters the die 108. For instance, suitable screens may include wire cloth screens as filter elements for trapping deposits therein. The screen changer 106 may be configured to swap in clean filters in exchange for clogged, dirty filters. For this purpose, the screen changer 106 may include any variety of mechanisms known in the art, such as, for example, a pivot-type, bolt-type, belt-type, rotary disc, or continuously-advanced screen filtration device. The screen changer 106 also may include mechanisms for backflushing one or more screens in the screen changer. For instance, in one embodiment, the screen changer 106 may include one or more screen pistons (not shown), which may open the flowpath 105 to an upstream spillway for inducing a flow reversal, which unclogs the screens. In particular, the opening of a spillway upstream from the screen changer 106 may result in a substantial drop in pressure behind the screen changer and a corresponding reversal of melt flow due to the pressure differential. A reversal in melt flow direction may result, not only in the unclogging of dirty filters, but also in a reduction in melt flow throughput downstream from the screen changer 106. Such a drop in downstream melt flow throughput may result in inconsistent product material properties. Due to the undesirable consequences of certain pressure-disrupting events, such as screen changes, backflushes, and gradual build-up of material and/or pressure in the extrusion system 100, an extruder ramp-up control system 120 may be provided.

FIG. 1 illustrates one embodiment of an extruder ramp-up control system 120. The extruder ramp-up control system 120 may include an operator interface 122 in communication with a controller 124. The operator interface 122 may include a monitor and keyboard, a touchscreen, a laptop, and/or any other device suitable for receiving input from a user. For example, the operator interface 122 may include software that prompts a user to input variables and reference values, such as time intervals, temperatures, pressure minimums, pressure maximums, safety factors, and ramp-up values.

The controller 124 may be any suitable type of controller known in the art, such as, for example, a programmable logic controller (“PLC”). The controller 124 may be in communication with an extruder speed potentiometer 128. The extruder speed potentiometer 128 may be configured to receive an input from a user relating to an extruder setting, and to convey a corresponding analog signal to the controller 124. The controller 124 also may be in communication with the extruder drive 110 of the extrusion system 100. Accordingly, the extruder speed potentiometer 128 may be configured to pass an extruder speed setting to the extruder drive 110 through the controller 124. In one embodiment, an extruder speed potentiometer or other extruder control means may be integral with, and/or incorporated into, the operator interface 122. The controller 124 may also be disposed in communication with the screen changer 106 and configured to determine when the screen changer 106 will undergo a pressure-disrupting event.

The extruder ramp-up control system 120 also may include at least one pressure sensor. For instance, in the embodiment illustrated in FIG. 1, the extruder ramp-up control system 120 includes an upstream pressure sensor 126 in communication with the flowpath 105 between the extruder 104 and the screen changer 106. The upstream pressure sensor 126 may be any type of sensor configured to detect a pressure of fluid melt in the flowpath 105, upstream from the screen changer 106. For example, the upstream pressure sensor 126 may be a pressure transducer configured to relay a detected pressure measurement as an analog or digital signal to the controller 124.

As illustrated in FIG. 1, the extruder ramp-up control system 120 may include any configuration of additional pressure sensors, such as the pressure sensor 132. For instance, the pressure sensor 132 may be disposed in the flowpath 105, downstream from the screen changer 106. In this embodiment, the controller 124 may be configured to receive pressure inputs from sensors disposed across the screen changer 106 for the purpose of detecting a pressure differential across the screen changer 106. As will be appreciated by one of skill in the art, any configuration of additional pressure and/or temperature sensors may be incorporated in the extrusion flow path and disposed in communication with the controller 124. Such sensors may, if desired, be implemented into additional calculations and threshold comparisons for optimizing the output of the extruder drive 110. However, operation of the extrusion system 100 will be described below with respect to an embodiment in which the upstream pressure sensor 126 is the only pressure sensor used.

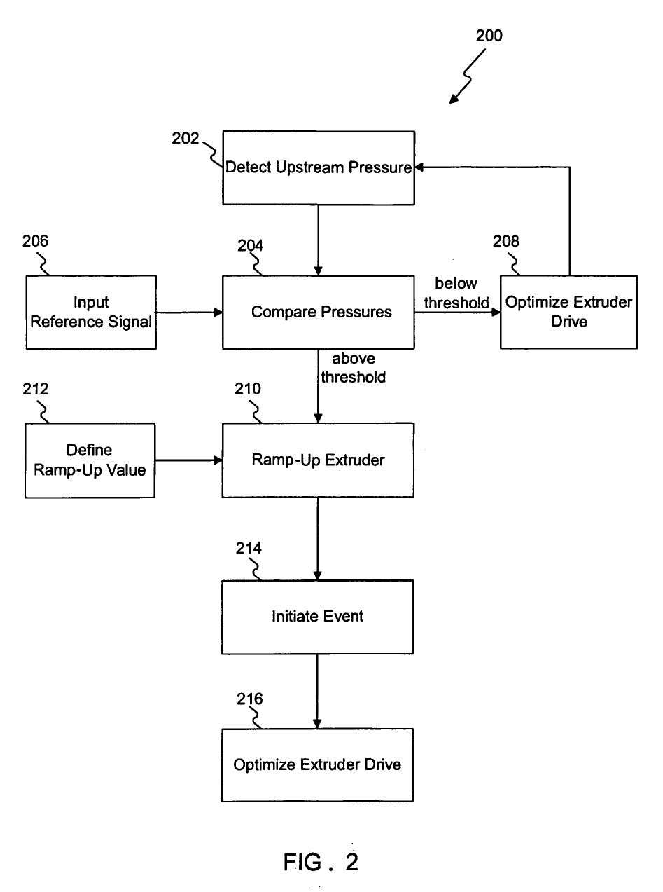

FIG. 2 illustrates one exemplary embodiment of an extruder ramp-up method 200 for implementing the extruder ramp-up control system 120 shown in FIG. 1. As illustrated at step 202, the extruder ramp-up method 200 may include the step of detecting the melt flow pressure upstream from the screen changer 106. At step 204, the pressure detected upstream from the screen changer 106 may be compared to a reference signal input at step 206. In one instance, a reference signal may be a pressure value input by an operator as a maximum threshold into the operator interface 122. Comparison between upstream pressure and the threshold pressure may be performed, for example, by the controller 124.

If the detected upstream pressure is below that of the threshold reference signal or setpoint, a continuous loop of optimizing the extruder drive at step 208 and detecting upstream pressure at step 202 may be performed at any preset time interval. In one embodiment, because the screen filters in the screen changer 106 may slowly clog and result in an upstream pressure build up over time, it may be desirable to increase extruder output to overcome the material flow deficiency resulting from such a clog. Thus, the step of optimizing the extruder drive may include incrementally increasing the extruder output over time in response to a detected increase in pressure behind the screen changer 106. For example, in one embodiment, for every 100 psi increase in upstream pressure, the controller 124 may add 0.2 Volts to the signal directed to the extruder drive 110. Accordingly, an incremental increase in pressure build up behind the screen changer 106 may be compensated for by higher extruder screw speed to maintain constant material output, even before the threshold pressure value of the reference signal is surpassed.

If, at step 204, the detected pressure is above that of the threshold reference signal, a more substantial output ramp-up process may be induced at step 210 in preparation for an impending disrupting event at step 214, such as a screen change or backflushing. Specifically, a user-defined ramp-up value (e.g., an extruder motor speed %) defined at step 212 may be added to the signal directed to the extruder drive 110 to overcome an anticipated drop in pressure. For example, in one embodiment, an operator may define a ramp-up value of 0-25% of the extruder motor speed using the operator interface 122. This increase in extruder output may be particularly defined by the operator interface 122 and/or by the controller 124. For example, the ramp-up may be sudden and complete, in advance of a disrupting event at step 214. Alternatively, the ramp-up may occur slowly, or in intervals, relative to the event. In one embodiment, ramping up of the extruder screw and output may occur just after the initiation of a disrupting event but prior to its effects. For example, it may be preferable to begin ramping up voltage to the extruder drive 110 after a backflushing screen piston begins moving, but before a spillway has opened. The system and method also may include a safety mechanism by which a maximum extruder output is not exceeded. For example, even if an operator inputs a ramp-up value of 25%, the extruder will only increase output by 5% if it is already operating at 95% capacity.

In some embodiments, it may be desirable to perform additional extruder drive optimization at step 216 in response to input from pressure and/or temperature signals. For example, minor variations in pressure may be detected on top of the predicted, major pressure-disrupting event. Compensation for these variations may be relatively small, so as to avoid interruption of the substantially anticipatory ramp-up function.

Unlike conventional extrusion systems and extruder ramp-up methods, the presently disclosed systems and methods may be configured to maintain substantially constant material flow properties even at a relatively high material flow rate. Moreover, the presently disclosed ramp-up system and method provide a more proactive solution to anticipated disruptions in flow pressure and material throughput, without the traditionally requisite use of closed-loop control and geared pumps. Thus, this advantageous result is accomplished even by the use of relatively inexpensive and unsophisticated instrumentation.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifieations and equivalents may be resorted to, falling within the scope of the invention.

What is claimed is:

1. An extrusion system comprising:
an extruder and a screen changer connected by a flow path;
a first pressure sensor disposed in the flow path between the extruder and the screen changer;
an operator interface configured to receive an input value; and
a controller in communication with the extruder, the first pressure sensor, and the operator interface;
wherein the first pressure sensor is configured to detect a pressure of material flowing from the extruder to the screen changer, and to generate a first signal in response to the detected pressure; and
wherein the controller is configured to adjust an operating condition of the extruder based on a comparison between the first signal and the input value.

2. The extrusion system of claim 1, further comprising:
an extruder drive in communication with an extruder motor of the extruder; and
an extruder speed potentiometer in communication with the controller;
wherein the extruder speed potentiometer is configured to modify an operating condition of the extruder drive using a signal sent through the controller.

3. The extrusion system of claim 1, wherein the controller is a programmable logic controller (“PLC”).

4. The extrusion system of claim 1, wherein the controller is further disposed in communication with the screen changer, said controller being further configured to initiate a pressure-disrupting event in the screen changer once the controller has adjusted an operating condition of the extruder.

5. The extrusion system of claim 1, further comprising:
a die connected to the flow path downstream from the screen changer;
a second pressure sensor disposed in the flow path between the screen changer and the die, said second pressure sensor being configured to detect a pressure of material flowing from the screen changer to the die, and to generate a second signal in response to the detected pressure; and
wherein the controller is configured to adjust an operating condition of the extruder in further response to the second signal.

6. The extrusion system of claim 1, further comprising:
at least one additional extruder connected to the screen changer, said extruder being configured to perform coextrusion.

7. A method of operating an extrusion system, comprising the steps of:
connecting an extruder and a screen changer with a flow path;
disposing a first pressure sensor in the flow path between the extruder and the screen changer;
providing an operator interface configured to receive an input value;
providing a controller in communication with the extruder, the first pressure sensor, and the operator interface;
detecting a pressure of material flowing from the extruder to the screen changer;
generating a first signal in response to the detected pressure; and
adjusting an operating condition of the extruder based on a comparison between the first signal and the input value.

8. The method of claim 7, wherein adjusting an operating condition of the extruder comprises increasing a screw speed of the extruder by a predefined ramp-up value.

9. The method of claim 7, further comprising determining when the screen changer will undergo a pressure-disrupting event.

10. The method of claim 9, wherein the operating condition is adjusted in advance of the pressure-disrupting event.

11. The method of claim 9, wherein the operating condition is adjusted after the pressure-disrupting event is initiated but prior to an effecting of a result based on the pressure-disrupting event.

12. A method of operating an extrusion system, comprising the steps of:
detecting a pressure upstream from an extrusion screen filter;
comparing the upstream pressure to a user-defined threshold pressure; and
increasing an extrusion output if the upstream pressure exceeds the threshold pressure.

13. The method of claim 12, wherein the step of increasing the extrusion output occurs by gradually ramping up voltage to an extrusion drive in response to a detection of user-defined pressure increments.

14. The method of claim 12, wherein the step of increasing the extrusion output occurs by suddenly and completely ramping up voltage to an extrusion drive based on a predefined ramp-up value.

15. The method of claim 12, further comprising determining when a pressure-disrupting event will occur.

16. The method of claim 15, wherein the step of increasing the extrusion output occurs in advance of the pressure-disrupting event.

17. The method of claim 15, wherein the step of increasing the extrusion output occurs after the pressure-disrupting event is initiated but prior to an effecting of a result based on the pressure-disrupting event.

18. The method of claim 15, wherein the pressure-disrupting event is one or more of: a screen change, a backflush, or a build-up of material in the screen changer.

19. A system for optimizing a flow property of a material extruded from an extruder through a screen changer comprising:
an extruder configured to extrude material having a variable material flow property;
a sensor disposed in communication with material flowing from the extruder to the screen changer, and
a controller configured to determine a material flow property of material downstream from the extruder based on a measurement by the sensor, said controller further being configured to optimize the variable material flow property of the material extruded by the extruder based on the sensed material flow property.

20. The system of claim 19, wherein the variable material flow property of the material is optimized by adjusting a screw speed of the extruder.
